(19) United States
(12) Patent Application Publication
(10) Pub. No.: US 2009/0174185 A1
(43) Pub. Date: Jul. 9, 2009

(54) Joint and Joinning Method for Multilayer Composite Tubing

(75) Inventor: Christopher G. Ziu, Lenexa, KS (US)

Correspondence Address: EDWARDS ANGELL PALMER & DODGE LLP, P.O. BOX 55874, BOSTON, MA, 02205, US

(73) Assignee: Orion Enterprises, Inc., Kansas City, KS (US)

(21) Appl. No.: 12/225,910

(22) PCT Filed: Mar. 27, 2007
(86) PCT No.: PCT/US07/07686

§ 371 Date: Oct. 1, 2008

Related U.S. Application Data
(60) Provisional application No. 60/744,212, filed on Apr. 4, 2006.

(51) Int. Cl. F16L 17/00; F16L 33/01; C09J 5/10

(52) U.S. Cl. 285/367; 285/260; 156/322

(57) ABSTRACT

A tubing assembly including elongated first and second tubes for carrying a fluid flow. Each tube is a composite tube having an inner layer, a middle layer surrounding the inner layer, and an outer layer surrounding the middle layer. At the end of each tube, the tubes are flared outward from an axis of the tubes in complimentary shapes with the middle layer being directed away from the fluid flow and following a contour of the inner layer. The tubing assembly may include a gasket provided intermediate the inner layers. A clamp compresses the ends together and the gasket (if provided) to create a joint between the inner layers of the ends and maintain a seal between the inner layers of the flared ends.

### CROSS-REFERENCE TO RELATED APPLICATION

This application claims priority to U.S. Provisional Patent Application No. 60/744,212, filed Apr. 4, 2006 which is incorporated herein by reference.

### TECHNICAL FIELD OF THE DISCLOSURE

The present disclosure relates to a joint and a joining method for multilayer composite tubing having at least one middle layer of malleable metal. The joint and joining method prevent the middle metal layer from being exposed to liquid flow within coupled tubes so that the tubes can meet stringent sanitary requirements.

### BACKGROUND OF THE DISCLOSURE

High purity water, which is highly purified through filtering, deionization, reverse osmosis, distillation, or some combination thereof, is extensively used in research as well as in the commercial manufacture of pharmaceutical products and electronic components. Once water has been purified, it must be run through pipes that are very stable, clean and smooth, or the water will tend to become contaminated through impurities gained from the piping materials. Over the last forty years, it has become widely recognized that thermoplastic materials are the cleanest, most stable, and smoothest materials that exist to convey high purity water. In the most extreme applications, where water is purified to the greatest extent possible (a condition referred to as 18.2 megaohm, which is the theoretical maximum resistance achievable in ultra pure water), such as in pharmaceutical or semiconductor chip manufacturing, polypropylene, polyvinylidene fluoride, and PFA materials have become the established materials of choice. These materials can be produced without pigmentation or other additives. These highly crystalline thermoplastics can be extruded into very smooth bores and joined with techniques that minimize internal imperfections in the bore of the piping.

In high purity water applications, pipe joining methods which produce the least internal irregularities or intrusions are preferable as any internal formations or crevices can lead to stagnant areas where bacteria or other microorganisms can grow. Bacteria or other microorganisms are very undesirable in high purity water applications, and particularly in applications where microorganisms can lead to adverse effects on the finished products or affect test results.

The best joint forming techniques to date for thermoplastic materials include bead and crevice-free butt-welding, which results in a virtually undetectable joint in the piping material. This method consists of heating the plain ends of pipes against a heating surface, and then butting the materials together while simultaneously inflating a device, a solid plug, or introducing a gas that prevents the formation of an internal bead. Examples of such a method are described in U.S. Pat. Nos.: 4,801,349; 4,923,659; and 5,188,697.

Butt-welding, however, is very labor intensive, and is typically performed on pipes with fixed lengths (e.g., 5 meter extruded lengths and separate fittings), which require a large number of welds. In addition, bead and crevice-free butt-welding cannot be performed on all of the joints in a piping system. Instead, flanged connections, union connections or other mechanical attachments are used on the joints that cannot be bead and crevice-free butt-welded.

Another method of joining which has been established over the years and which is readily accepted in high purity industries is the use of sanitary quick disconnect couplings. This type of joint consists of flared flanged ends on pipe and fittings which are formed to accept a gasket of matching shape that when compressed together by means of an external clamp. The clamp compresses the gasket to result in a joint that is nearly bead and crevice free. The type of clamps which are used to make such joints have often been referred to as Tri-Clover® (registered trademark of Tri-Clover/Alfa-Laval) and Tri-clamp® (registered trademark of Ladish Co. of Cudahy, Wis.). The consistency of the results of the joints, plus the ability for such joints to be readily disconnected and reassembled to allow for cleaning has made this type of connection a standard in high purity, pharmaceutical, food, dairy and beverage industries for many years. Since the materials can be completely disassembled, the parts can be steam-cleaned or sanitized directly and can thereby limit the clean in place (CIP) requirements, making it a very desirable method.

In the early 1980s, polypropylene and polyvinylidene fluoride thermoplastic tubing and fittings started to be used in high purity applications with a sanitary quick disconnect coupling method as the joining system. The method formed sanitary quick disconnect couplings by directly applying a ferrule on the ends of the tubing by means of a flange forming tool. This tool and the method of using the tool are described in U.S. Pat. No. 4,398,879.

The system of U.S. Pat. No. 4,398,879 has continued to be useful even to this day. However, the method is not without its share of problems and limitations. For example, if this type of flaring is to be performed on straight thermoplastic tubing, the tubing must be somewhat limited in wall thickness. If the tubing becomes too thick, then the tubing will not heat evenly enough to allow for flaring to be accomplished. However, single layer, non-reinforced thermoplastic tubing that is thin walled will inherently have a lower fluid pressure rating. In addition, thin walled non-reinforced thermoplastic tubing is more normally supplied in fixed lengths, which means that installation of such a system requires an extensive amount of joints. Furthermore, since thermoplastics such as polypropylene (PP) and polyvinylidene fluoride (PVDF) are subject to creep, and field-formed parts become an area of high stress, the flared joints are subject to possible loosening over time, resulting in leaking. In critical applications involving a lot of stress, the flares can even fail by cracking due to creep rupture at the weakened points.

To overcome some of the drawbacks of using metallic clamps on the field formed thermoplastic flares, a three-part injection molded thermoplastic part was conceived and made from a strong plastic such as PVDF. This three-part clamp is described in U.S. Pat. No. 5,176,411. This part addresses some of the concerns of joint loosening due to creep of the plastic flared flanges. However, such a coupling tends to be expensive in comparison to more economical metallic clamps.

In the 1990s, multilayer thermoplastic tubing was introduced which consisted of an inner layer of thermoplastic material (such as PP, polyethylene (PE) or cross-linked polyethylene (PEX)), an intermediate malleable metallic layer such as welded aluminum or copper, and an outer layer such as PE, PEX or PP. Further, the inner and outer layers are typically also bonded to the aluminum by means of an adhesive layer to result in a gas tight construction, reducing permeation. Such an assembly results in tubing which can be made with thin layers for economy, yet has reasonably high pressure ratings compared to thicker straight thermoplastic tubing due to the metallic layer, even at elevated temperatures. Further, the tubing is flexible due to the malleable nature of the metallic products involved, and since the inner and outer layers are relatively thin, the tubing can be flexed or bent, with the inner and outer layers conforming to the bending of the metallic substrate. The multilayer tubing can therefore be delivered in coiled bundles, yet rolled out straight. In addition, where elbows are required, the elbows can be permanently field-formed on the tubes. The extrusion process to make this five layer composite tubing was developed by SwissCab, SA (now referred to as APSwissTech SA of Yvonand, Switzerland). Piping made from this process has gained popularity in potable water systems, for both hot and cold water lines, as well as for air carrying lines.

What is still desired is a new and improved joint and method for joining tubing for sanitary uses. The joint and joining method will preferably be usable with multilayer composite tubing having at least one middle layer of malleable metal, and will prevent the middle metal layer from being exposed to liquid flow within coupled tubes so that the coupled tubes can meet the stringent sanitary requirements. In addition, the joining method can preferably be conducted in the field during installation of the tubing.

### SUMMARY OF THE DISCLOSURE

The present disclosure provides a joint and method of joining multilayer composite tubing. Among other aspects and advantages, the joint and joining method of the present disclosure are usable with multilayer composite tubing having at least one middle layer of malleable metal. The joint and joining method of the present disclosure prevent the middle metal layer of the tubing from being exposed to liquid flow within coupled tubes so that the coupled tubes can meet stringent sanitary requirements. In addition, the joining method can be conducted in the field during installation of the tubing.

In one embodiment, the subject disclosure is directed to a tubing assembly including elongated first and second tubes for carrying a fluid flow. Each tube is a composite tube having an inner layer, a middle layer surrounding the inner layer, and an outer layer surrounding the middle layer. At the end of each tube, the tubes are flared outward from an axis of the tubes in complimentary shapes with the middle layer being directed away from the fluid flow and following a contour of the inner layer. A clamp compresses the ends together to create a joint between the inner layers of the ends and maintain a seal between the inner layers of the flared ends. The joint may further include a gasket provided intermediate the inner layers and compressed therebetween.

The subject disclosure is also directed to a method for joining multilayer tubes. The tubes have an inner layer, a middle layer surrounding the inner layer, and an outer layer surrounding the middle layer. The method includes the steps of creating a flange on an end of first and second multilayer tubes by flaring the inner layer of the multilayer tubes outward, forming a half o-ring recess in the inner layer of each flange, providing a gasket in one of the half o-ring recesses, and joining the flanges of the first and second multilayer tubes to compress the gasket and sealingly engage the inner layers.

Still another embodiment of the subject disclosure is a fitting including a central portion of multilayer composite, a first end extending from the central portion and a second end extending from the central portion, wherein at least one of the ends is flared approximately perpendicularly away from an axial length of the central portion to prevent a middle layer of the multilayer composite from contacting fluid passing through the fitting.

Yet another embodiment of the subject disclosure is a multilayer composite tube for forming a joint in a fluidic network, the tube includes an adapter having a tubular body having a beveled end and a flanged end. The flanged end defines an annular recess for a gasket. The tube has an end adapted and configured to be fused with the adapter when heated.

The subject disclosure is also directed to a method of forming a joint in a fluidic network. The method includes the steps of providing an adapter having a tubular body having a beveled end and a flanged end, shaping an end of a tube to receive the adapter, placing the end on a male mandrel of a socket fusion tool to heat the end, placing the adapter on a female mandrel of the socket fusion tool to heat the adapter, removing the end and the adapter from the respective mandrel and inserting the adapter into the end to fuse the adapter and the end together. Preferably, the method also includes forming the adapter and the end with complimentary profiles, wherein the end is shaped using the male mandrel of the socket fusion tool.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF DRAWINGS

Reference is made to the attached drawings, wherein elements having the same reference character designations represent like elements throughout, and wherein:

FIG. 1 is a schematic view of a tubing assembly including an exemplary embodiment of a joint for joining multilayer composite tubing constructed in accordance with the present disclosure, wherein two multilayer composite tubes are shown coupled together;

FIG. 2 is an enlarged sectional end view of one of the multilayer composite tubes of FIG. 1;

FIG. 3 is an enlarged sectional view of the joint of FIG. 1, which includes exemplary embodiments of flared ends of the multilayer composite tubes, a gasket located between the flared ends, and a clamp securing the flared ends together with the gasket compressed there between to provide a fluid-tight coupling;

FIG. 4 is a further enlarged sectional view of one of the flared tube ends of FIG. 1;

FIG. 5 is an enlarged end view of the gasket of FIG. 1;

FIG. 6 is a sectional view of the gasket of FIG. 1 taken along line 6-6 of FIG. 5;

FIG. 7 is an enlarged end view of the coupling of FIG. 1 shown with an alternative tightening member;

FIG. 8 is a sectional view of a multilayer composite elbow fitting including exemplary embodiments of flared ends according the present disclosure, which may be formed in the field;

FIG. 9 is a sectional view of a reducer coupling including exemplary embodiments of flared ends according the present disclosure, which may be formed in the field;

FIG. 10 is a sectional view of another exemplary embodiment of a tool according to the present disclosure for forming a flared end for a multilayer composite tube;

FIG. 11 is a sectional view of the flared end formed using the method of FIG. 10;

FIG. 12 is a sectional view of a further exemplary embodiment of a method according to the present disclosure of forming a flared end for a multilayer composite tube; and

FIG. 13 is a sectional view of the flared end formed using the method of FIG. 12.

### DETAILED DESCRIPTION OF EXEMPLARY EMBODIMENTS

The present disclosure overcomes many of the prior art problems associated with joints and joining multilayer composite tubing. In general, the joints and joining methods are used to create extensive yet highly sanitary plumbing networks. Among other features and benefits, the disclosed joints and joining methods facilitate field easy installation and can create complex configurations of piping. The advantages, and other features of the system disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

All relative descriptions herein such as upward, downward, left, right, up, down, length, height, width, thickness and the like are with reference to the Figures, and not meant in a limiting sense. Additionally, the illustrated embodiments can be understood as providing exemplary features of varying detail of certain embodiments, and therefore, features, components, modules, elements, and/or aspects of the illustrations can be otherwise combined, interconnected, sequenced, separated, interchanged, positioned, and/or rearranged without materially departing from the disclosed joints or joining methods. Additionally, the shapes and sizes of components are also exemplary and can be altered without materially affecting or limiting the disclosed technology.

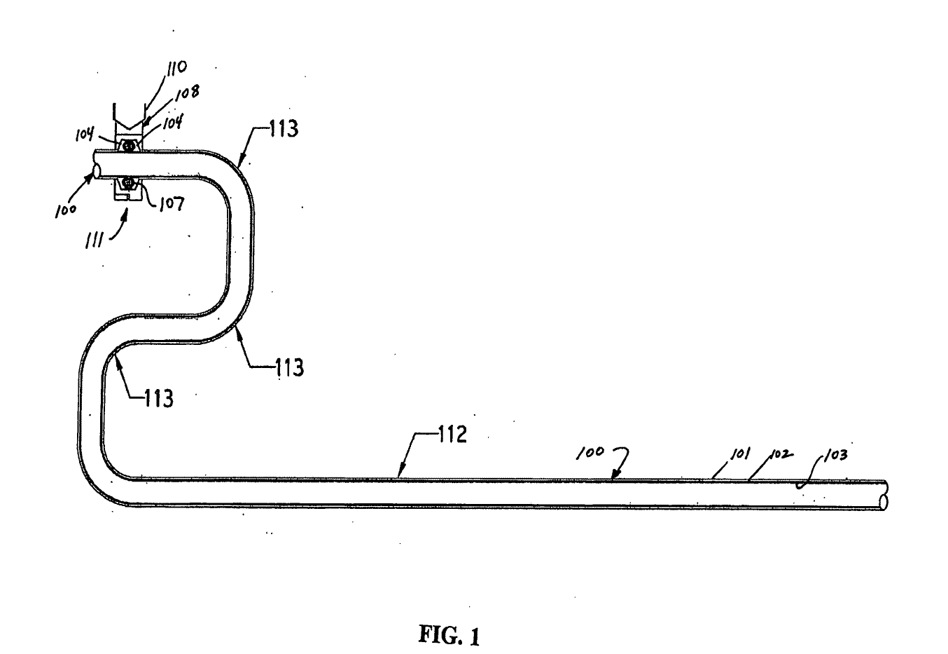

Referring first to FIG. 1, a tubing assembly 112 including a first exemplary embodiment of a joint 111 according to the present disclosure for joined multilayer composite tubes 100 is shown. The joint 111 includes exemplary embodiments of flared ends 104 of the multilayer composite tubes 100, a gasket 106 located between the flared ends 104, and a coupling or external clamp 108 securing the flared ends together with the gasket 106 compressed there between to provide a fluid-tight coupling joint 111.

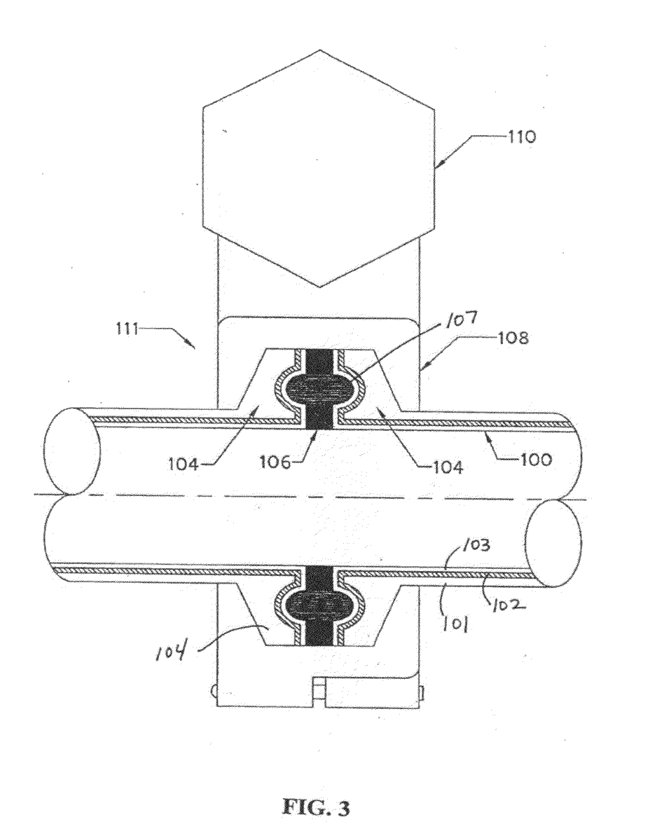

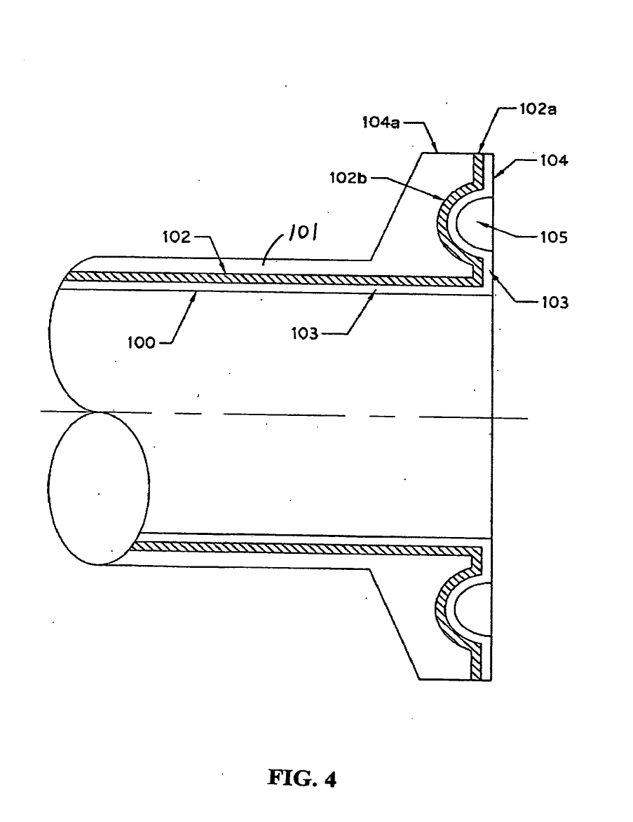

An enlarged view of the joint 111 is shown in FIG. 3, and enlarged views of the flared ends 104 are shown in FIGS. 3 and 4. As shown each flared end, which may be formed in the field during pipe installation, is uniquely formed in accordance with the present disclosure such that an intermediate malleable metal layer of the multilayer composite tubing will not be exposed to fluid flowing through the coupled tubes.

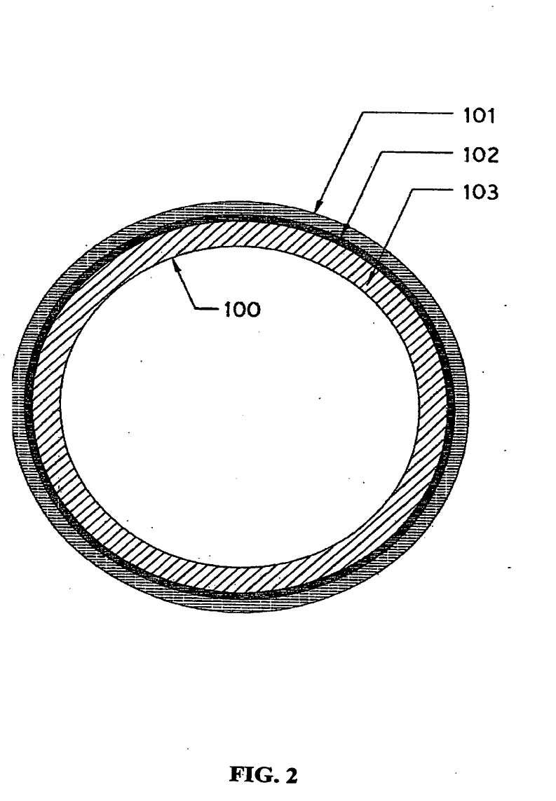

FIG. 2 shows a cross-sectional view of one of the multilayer thermoplastic-metallic-adhesive composite tubes 100, which, in the exemplary embodiment shown, includes five layers. This five-layer construction consists of an inner layer 103 of extruded thermoplastic material, consisting of a material such as PP, PVDF, VF2-HFP copolymer (copolymer of vinylidene fluoride and hexafluoropropylene comonomers), PFA (perfluoroalkoxyalkane polymer), HDPE (high density polyethylene) or PEX. The inner layer 103 is preferably manufactured from a natural, unpigmented form of one of these resins when the multilayer pipe 100 is being used for the transport of high purity water substances.

Although not viewable in FIG. 2, the five-layers include an adhesive layer provided on the exterior of the inner layer 103. A layer 102 of malleable metal, such as aluminum or copper, is formed around the adhesive layer provided on the exterior of the inner layer 103. The malleable metal layer 102 is formed, for example, by means of welding using laser-welding techniques, which results in a very uniform layer. Surrounding the middle malleable metal layer 102 is a fourth layer which is another application of adhesive.

The outer fifth layer 101 is also an extruded thermoplastic, which can be from among one of the same resins described above. The outer layer 101 may be a pigmented material which has ultraviolet light additives for protection of the outer thermoplastic layer when using PP, HDPE or PEX, each of which are potentially affected by sunlight. In this manner, the inner layer 103 has the best form of the material to maintain purity, while the outer layer 101 has the best protection of the multilayer pipe 100 against external ambient effects. Also, the inner layer 103 can be one material and the outer layer 101 can be another material. In this manner, an expensive material such as PVDF can be used as the inner layer 103 and the outer layer 101 can be a less expensive material such as PP or HDPE, thereby making the entire assembly 100 an economical overall combination while preserving the performance characteristics of the inner most material 103. As a result, the assembly 100 can be less expensive than a more expensive solid pipe of equivalent overall thickness.

The flared, sanitary quick-disconnect ends 104 are shown best in FIGS. 3 and 4. This type of joint can be formed directly onto the end of a cut piece of multilayer tubing 100 using the type of forming tool described in U.S. Pat. No. 4,398,879, or similar device adapted to provide the correct amount of heating and joining force. When this type of flange 104 is formed on the multilayer tube 100, the malleable metallic middle layer 102 follows the contour being shaped into the end of the inner layer 103, which is first flared outward and then subsequently into the geometry shown by the completed flange 104.

A half o-ring recess 105 is formed as part of the flange to accept the matching gasket 106, as shown in FIGS. 3 and 4, when a completed joint is made. When the half o-ring recess 105 is formed into the flared flange 104, the malleable metallic middle layer 102 of the multilayer tubing 100 follows the recess in the same curved shape shown as 102b. In the completed shape, an end 102a of the malleable metallic middle layer 102 of the multilayer tube 100 is flared out and away from the inside diameter of the tubes 100 so that the end 102a is located on the external outward portion 104a of the flange 104. As a result, the end 102 is remote from the internal water stream passing through the coupled tubes 100. In the embodiment shown, the ends 102a are located perpendicularly away from the axial length of the tubes 100 but the subject disclosure is by no means limited to such a configuration.

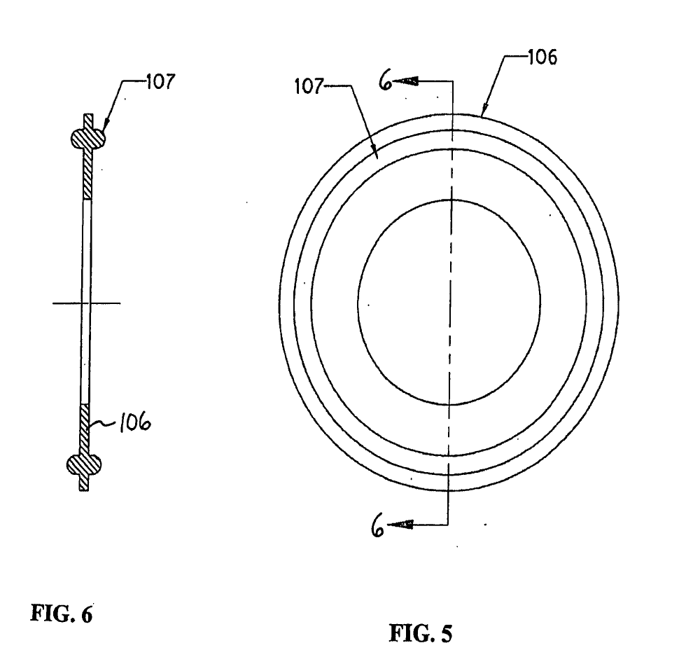

As best seen in FIG. 3, the gasket 106 forms a portion of the inner surface of the joined tubes. In other words, the gasket 106 seals against the inner layer 103 of each tube and is shaped to maintain the inner profile so undesirable crevices are avoided. Referring to FIGS. 5 and 6, a side view and cross-sectional view, respectively, of a gasket 106 are shown. The gasket 106 has a substantially rectangular cross-sectional shape except for having a half o-ring bump 107. In another embodiment, no gasket or a simple annular gasket contained within the o-ring recesses 105 are used and the inner layers 103 are urged directly together to form an effective seal.

One of the major drawbacks of multilayer tubes in the past has been that the malleable metallic material winds up in direct contact with the water stream if an external seal type of coupling is used. This problem is overcome in potable water applications by using a barbed type of internal coupling such as brass or PVDF, which the tube can then be crimped over. However, in high purity water this would be an undesirable joint. Thus, by flaring the malleable metal middle layer 102 away and outward into misalignment between the tubes 100 (e.g., out of the water stream) into the configuration shown as 102a, contact between the middle layer 102 and water stream is avoided. Thus, the joint 111 is readily accepted into high purity water. The problems of the prior art are overcome and the multilayer tubing 100 becomes very usable and desirable due to its other inherent advantages.

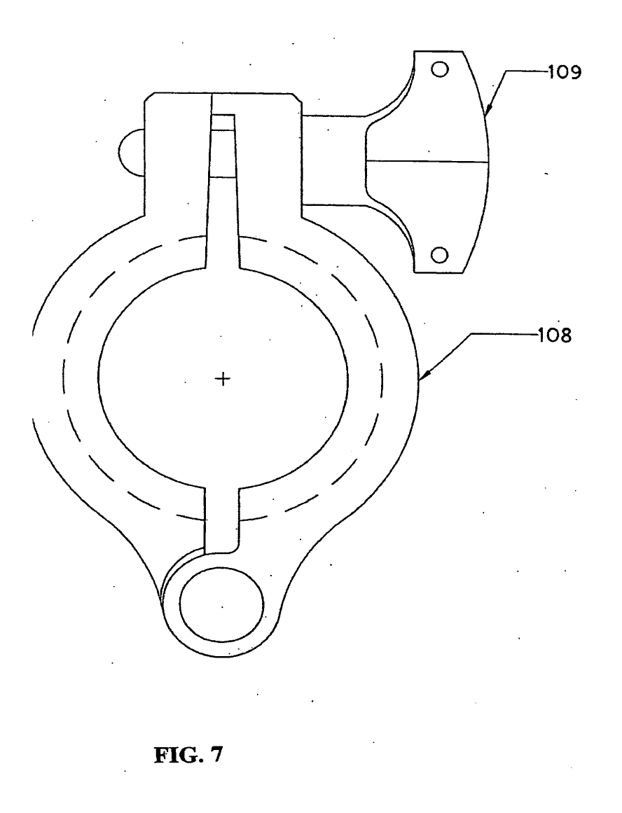

Referring to FIGS. 1 and 3, the external clamp 108 causes the compression to occur when joining two adjacent flared ends 104 surrounding the matching gasket 106. The clamp 108 can have various configurations of tightening members such as the handle-type 109 shown in FIG. 7, or the hex nut 110 shown in FIG. 1. The completed joint assembly 111 is shown in FIGS. 1 and 3. A wide variety of clamps can be used, including the three piece molded type described in U.S. Pat. No. 5,176,411, amongst others. As can be seen, the completed joint assembly 111 can be disassembled to allow for easy and effective cleaning. The assembly 112 of FIG. 1 illustrates how a long straight section (e.g., 100 feet or more) of multilayer tubing 100 can be formed into a long curved section without joints. A certain number of consecutive elbows 113 can be field-formed into bends without any joints, using an insertable/removable flexible internal packing and bending tool. The elimination of a vast majority of joints is a highly desirable attribute in high purity water systems. In the prior art, the elimination of joints has only been achieved by producing bead-and-crevice free joints on fixed lengths of pipes and tubing, and which is a much more expensive and time-consuming undertaking.

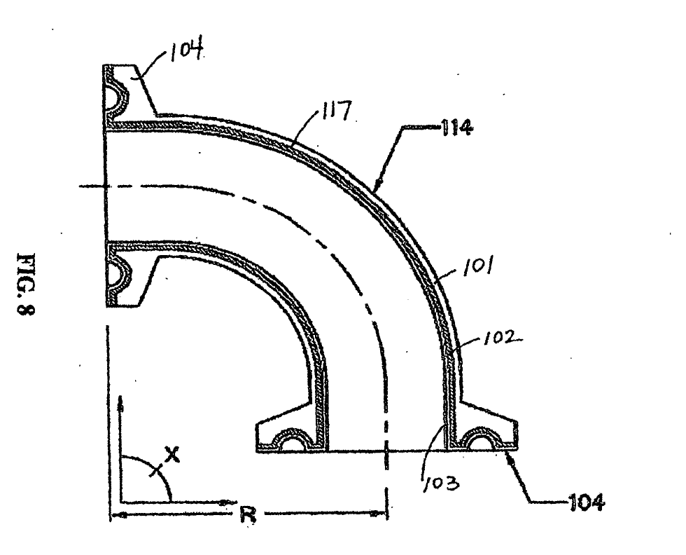

FIG. 8 shows a multilayer composite elbow fitting 114 including the flared ends 104 of the present disclosure. The elbow fitting 114 has an arcuate central portion 117 terminating in flared ends 104 similar to that described above. Each end 104 is flared approximately perpendicularly away from an axial length of the central portion 117 to prevent a middle layer 102 of the multilayer composite from contacting fluid passing through the fitting 114. The elbow fitting 114 can be shop-formed using the same bending tools and flange flaring equipment used in the field to result in an off-the shelf fitting which has sanitary quick disconnect ends 104. Elbow fittings with a wide variety of radii R (e.g. 1 times the diameter, 1.5×D, 2×D, 3×D, etc.) and bend angles X (e.g. 30°, 45°, 60°, 75°, 90°, etc.) can be formed in this manner.

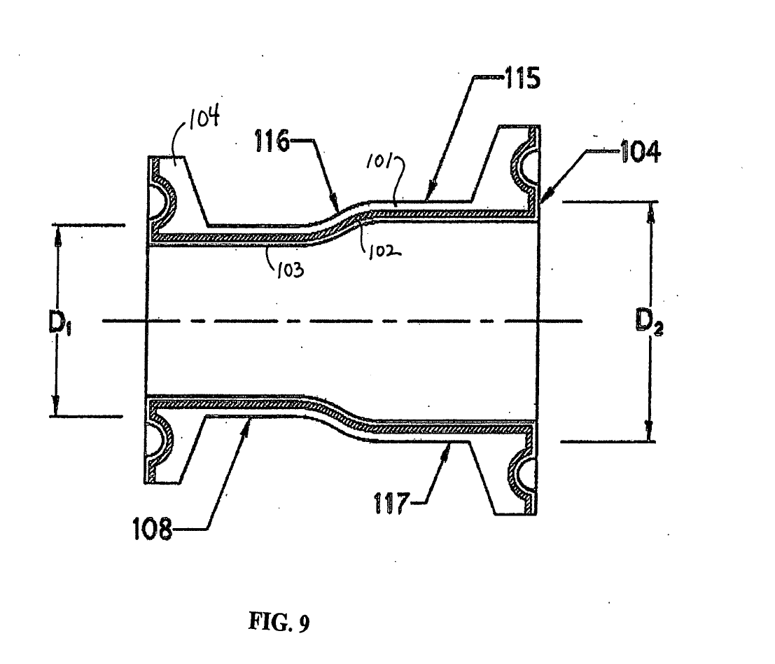

Similarly, off the shelf reducers 115 can be formed using a heating and flaring mandrel. FIG. 9 shows a reducer coupling 115 including the flared ends 104 of the present disclosure. The reducer 115 is formed by starting with a section of tubing of diameter D₁ and then flaring one end with a smooth concentric tapered shape 116 to result in a second diameter D₂. The ends of D₂ and D₁ can then be formed into the flared sanitary quick disconnect flanged ends 104 to result in the completed fitting 115.

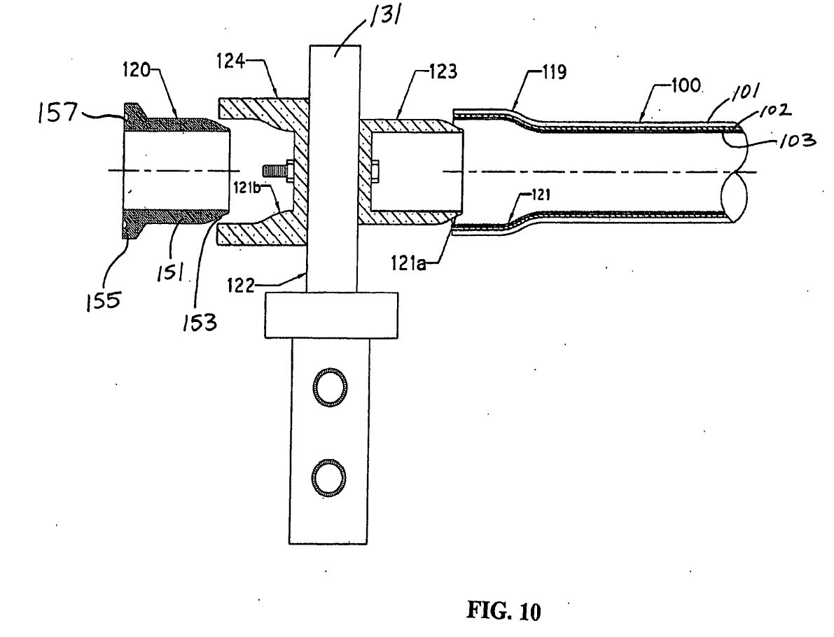

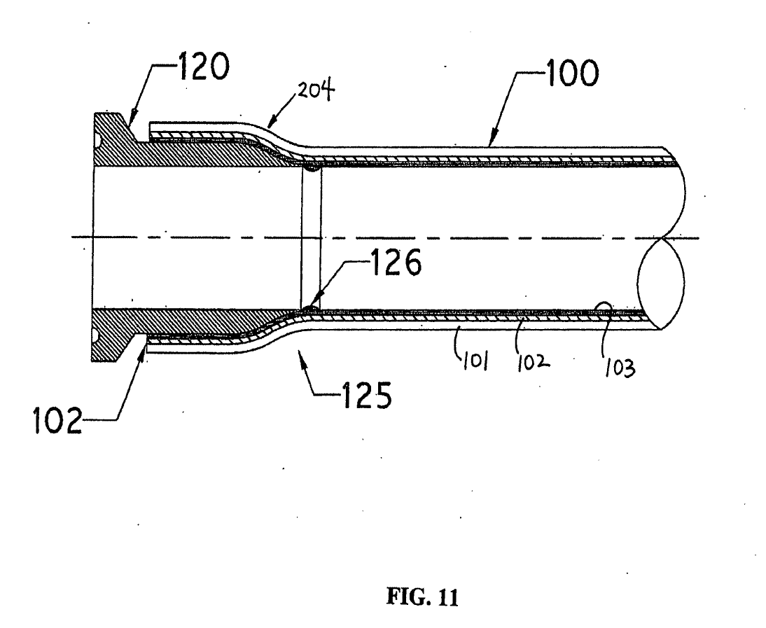

An alternate way to arrive at a field joint which would add a sanitary quick disconnect option would be to use a molded adapter 120, as shown in FIGS. 10 and 11. The field joint can be easily used in any fluidic network. The molded adapter 120 has a tubular body 151 with a beveled end 153 and a flanged end 155. The flanged end 155 defines an annular recess 157 for a gasket (not shown). The end 119 of the tube 100 and the molded adapter 120 are shaped and fabricated to be fused together.

As shown in FIG. 11, the molded adapter 120 can be socket fused to an end 102 of the tube 100 using a socket fusion tool 122 as the source of heat Thus, elaborate flaring and contouring of the tube end 102 is not required. Rather, simple heating of the molded adapter 120 and the tube end 102, preferably simultaneously, with minimal shaping of the tube end 102 allows for easy, effective and permanent connection of the molded adapter 120 to the tube end 102.

The socket fusion tool 122 includes coated aluminum male and female heating mandrels 123, 124 attached to a heating element 131 so that heat is transferred from the socket fusion tool 122. The male mandrel 123 is shaped with an end profile 121a so that a tapered socket 119 (also referred to as a belled shape) is formed into the end 102 of the multilayer tubing 100 when the tubing 100 is forced over the heated male mandrel 123. The socket fusion tool 122 produces an inside profile 121 into the belled end 119. On the opposite side of the heating element 131, the female mandrel 124 is designed with an inside profile 121b to form a matching shape onto the molded adapter end 120.

Once the molded adapter 120 and tube end pipe 102 are heated and formed with complimentary profiles, the molded adapter 120 and tube end 102 are removed off of the respective mandrel 123, 124. Then, the molded adapter 120 is inserted into the tube end 102 to fuse together and complete the joint 125 between the molded adapter 120 and tube end 102. The completed joint 125, which is shown in FIG. 11, may have an internal bead protrusion 126, which is less desirable than the smooth joint type produced by the sanitary quick disconnect style noted above. It is envisioned that the molded adapter 120 could also be fused onto tube portions to create elbow fittings, reducers and the like.

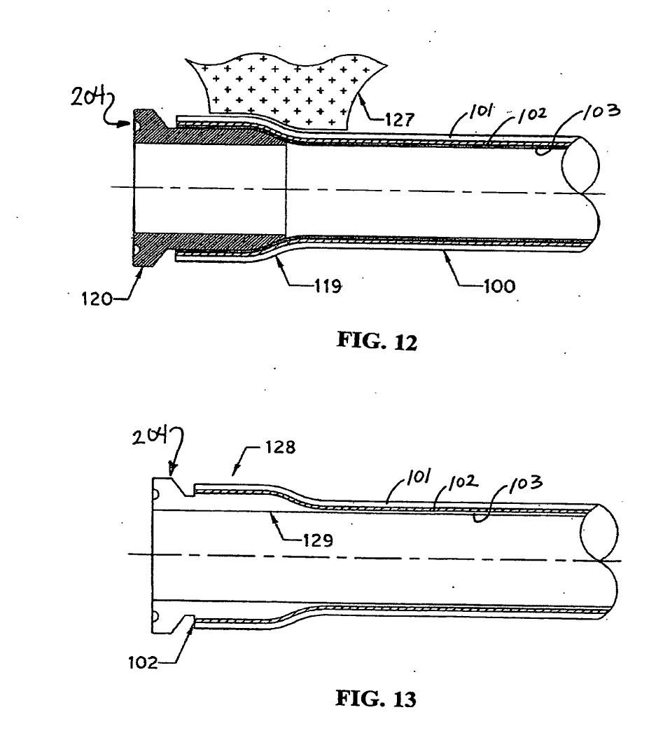

Another variation of socket fusion joint style is to first form the belled socket shape 119 into the multilayer pipe 100 using the socket fusion tool 122 shown in FIG. 10, and then join the molded adapter 120 into the socket 119 using ultrasonic welding, as shown in FIG. 12. An ultrasonic welding horn 127 is preferably of the rotating head type, similar to that used for welding small diameter metallic tubes. Using this technique, the completed joint 128 has a smooth bore that is essentially seamless 129 as shown in FIG. 13. While potentially a more expensive technique than simply forming the flanged end 104, this technique does result in the same net finished shape as the formed end 104 of FIG. 11.

### INCORPORATION BY REFERENCE

All patents, published patent applications and other references disclosed herein are hereby expressly incorporated in their entireties by reference.

The present disclosure provides a new and improved joint and method of joining multilayer composite tubing. It should be understood, however, that the exemplary embodiments described in this specification have been presented by way of illustration rather than limitation, and various modifications, combinations and substitutions may be effected by those skilled in the art without departure either in spirit or scope from this disclosure in its broader aspects.

What is claimed is:

1. A tubing assembly comprising:
a) elongated first and second tubes for carrying a fluid flow,
each tube being a composite tube having at least an inner layer, a middle layer surrounding the inner layer, and an outer layer surrounding the middle layer, and
each tube having an end, wherein the ends are flared outward from an axis of the tubes in complimentary shapes with the middle layer being directed away from the fluid flow and following a contour of the inner layer; and
b) a clamp for compressing the ends together to create a joint between the inner layers of the ends and maintain a seal between the inner layers of the flared ends.

2. A tubing assembly as recited in claim 1, wherein each tube has five-layers.

3. A tubing assembly as recited in claim 2, wherein the five-layers include: the inner layer; a first adhesive layer provided on an exterior of the inner layer, the middle layer of malleable metal; a second adhesive layer provided on the exterior of the middle layer; and the outer layer.

4. A tubing assembly as recited in claim 1, wherein the inner and outer layers are extruded thermoplastic.

5. A tubing assembly as recited in claim 1, wherein the inner layer is a different material than the outer layer.

6. A tubing assembly as recited in claim 1, wherein the ends are formed perpendicularly away from an axial length of the tubes.

7. A tubing assembly as recited in claim 1, further comprising a gasket provided intermediate the inner layers and compressed therebetween.

8. A method for joining multilayer tubes, the tubes having an inner layer, a middle layer surrounding the inner layer, and an outer layer surrounding the middle layer, the method comprising the steps of:
creating a flange on an end of first and second multilayer tubes by flaring the inner layer of the multilayer tubes outward; and
joining the flanges of the first and second multilayer tubes to sealingly engage the inner layers.

9. A method as recited in claim 8, wherein the middle layer follows a contour of the inner layer.

10. A method as recited in claim 8, further comprising the steps of:
bending at least one of the first and second multilayer tubes into a desired shape forming a half o-ring recess in the inner layer of each flange;
providing a gasket in one of the half o-ring recesses; and
providing a compressive force against the gasket during the joining step.

11. A fitting for quick and sanitary connection comprising:
a central portion of multilayer composite;
a first end extending from the central portion; and
a second end extending from the central portion,
wherein at least one of the ends is flared approximately perpendicularly away from an axial length of the central portion to prevent a middle layer of the multilayer composite from contacting fluid passing through the fitting.

12. A fitting as recited in claim 11, wherein the central portion is an elbow having a radii selected from the group consisting of a radii one time a diameter thereof, 1.5 times the diameter thereof, 2 times the diameter thereof, 3 times the diameter thereof, and 4 times the diameter thereof.

13. A fitting as recited in claim 11, wherein the central portion is a reducer.

14. A fitting as recited in claim 11, wherein the first and second end include a molded adapter fused to the central portion.

15. A fitting as recited in claim 11, wherein the multilayer composite has an inner layer on each end that is flared approximately perpendicularly away from the axial length of the central portion such that the inner layer forms a sealing surface.

16. A multilayer composite tube for forming a joint in a fluidic network comprising:
an adapter having a tubular body having a beveled end and a flanged end, the flanged end defining an annular recess for a gasket; and
an end of the multilayer composite tube, wherein the adapter and the end are fused together by heating.

17. A tube as recited in claim 16, wherein the end is bell-shaped.

18. A method of forming a joint in a fluidic network comprising the steps of:
providing an adapter having a tubular body having a beveled end and a flanged end;
shaping an end of a tube to receive the adapter;
placing the end on a male mandrel of a socket fusion tool to heat the end;
placing the adapter on a female mandrel of the socket fusion tool to heat the adapter;
removing the end and the adapter from the respective mandrel; and
inserting the adapter into the end to fuse the adapter and the end together.

19. A method as recited in claim 18, further comprising the step of forming an internal bead protrusion in the tube.

20. A method as recited in claim 18, further comprising the step of forming the adapter and the end with complimentary profiles, wherein the end is shaped using the male mandrel of the socket fusion tool.
